(19) United States
(12) Patent Application Publication
(10) Pub. No.: US 2024/0085192 A1
(43) Pub. Date: Mar. 14, 2024

(54) SYSTEMS AND METHODS FOR DETERMINING A PUBLIC TRANSPORTATION SCORE

(71) Applicant: HERE GLOBAL B.V., Eindhoven (NL)

(72) Inventors: Jerome Beaurepaire, Nantes (FR); Nicolas Neubauer, Berlin (DE)

(21) Appl. No.: 17/941,340

(22) Filed: Sep. 9, 2022

(51) Int. Cl. G01C 21/34

(52) U.S. Cl. CPC G01C 21/3415; G01C 21/3423; G01C 21/3492

(57) ABSTRACT

Systems and methods for determining a public transportation score are provided. For example, a method of determining a public transportation score includes receiving a public transportation metric associated with a first location within a public transportation network. The method also includes determining one or more elements of the public transportation network capable of affecting the public transportation metric. The method also includes determining a status of the one or more elements of the public transportation network. The method also includes based on the status of the one or more elements, determining a score corresponding to the public transportation metric.

### TECHNICAL FIELD

The present disclosure relates generally to public transportation networks, and more specifically to systems and methods for determining a public transportation score.

### BACKGROUND

Navigation systems typically determine timing information for a navigation route that utilizes a public transpiration network based on static information such as, for example, distance between a starting location and a destination location. However, it is typically difficult for a navigation system to accurately determine how the status of one or more elements of the public transportation network may affect the navigation route.

### BRIEF SUMMARY

The present disclosure overcomes the shortcomings of prior technologies. In particular, a novel approach for determining a public transportation score is provided, as detailed below.

In accordance with an aspect of the disclosure, a method for determining a public transportation score is provided. The method includes receiving a public transportation metric associated with a first location within a public transportation network. The method also includes determining one or more elements of the public transportation network capable of affecting the public transportation metric. The method also includes determining a status of the one or more elements of the public transportation network. The method also includes, based on the status of the one or more elements, determining a score corresponding to the public transportation metric.

In accordance with another aspect of the disclosure, an apparatus determining a public transportation score is provided. The apparatus includes a processor. The apparatus also includes a memory comprising computer program code for one or more programs. The memory and the computer program code are configured to cause the processor of the apparatus to receive a public transportation metric associated with a first location of a public transportation network. The computer program code is further configured to cause the processor of the apparatus to determine one or more elements of the public transportation network capable of affecting the public transportation metric. The computer program code is further configured to cause the processor of the apparatus to determine a status of the one or more elements of the public transportation network. The computer program code is further configured to cause the processor of the apparatus to, based on the status of the one or more elements, determine a score corresponding to the public transportation metric.

In accordance with another aspect of the present disclosure, a non-transitory computer-readable storage medium is provided. The non-transitory computer-readable storage medium includes one or more sequences of one or more instructions for execution by one or more processors of a device. The one or more instructions which, when executed by the one or more processors, cause the device to receive a public transportation metric associated with a first location of a public transportation network. The one or more instructions which, when executed by the one or more processors, further cause the device to determine one or more elements of the public transportation network capable of affecting the public transportation metric. The one or more instructions which, when executed by the one or more processors, further cause the device to determine a status of the one or more elements of the public transportation network. The one or more instructions which, when executed by the one or more processors, further cause the device to, based on the status of the one or more elements, determine a score corresponding to the public transportation metric.

In addition, for various example embodiments, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment.

For various example embodiments, the following is also applicable: a method comprising facilitating access to at least one interface configured to allow access to at least one service, the at least one service configured to perform any one or any combination of network or service provider methods (or processes) disclosed in this application.

For various example embodiments, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment, and/or at least one signal resulting from one or any combination of methods (or processes) disclosed in this application as relevant to any embodiment.

For various example embodiments, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment, and/or at least one signal resulting from one or any combination of methods (or processes) disclosed in this application as relevant to any embodiment.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of the claims.

Still other aspects, features, and advantages are readily apparent from the following detailed description, simply by illustrating a number of particular embodiments and implementations. The drawings and description are to be regarded as illustrative in nature, and not as restrictive.

### BRIEF DESCRIPTION OF THE DRAWINGS

The embodiments are illustrated by way of example, and not by way of limitation, in the figures of the accompanying drawings:

FIG. 1 is a diagram of a system capable of determining a public transportation score, in accordance with aspects of the present disclosure;

FIG. 2 is a diagram of a geographic database, in accordance with aspects of the present disclosure;

FIG. 3 is a diagram of the components of a data analysis system, in accordance with aspects of the present disclosure;

FIG. 4 is a flowchart setting forth steps of an example process, in accordance with aspects of the present disclosure;

FIG. 5 is a diagram of an example computer system, in accordance with aspects of the present disclosure;

FIG. 6 is a diagram of an example chip set, in accordance with aspects of the present disclosure; and

FIG. 7 is a diagram of an example mobile device, in accordance with aspects of the present disclosure.

### DESCRIPTION OF SOME EMBODIMENTS

Examples of a method, apparatus, and a non-transitory computer-readable storage medium for determining a public transportation score are disclosed. In the following description, for the purposes of explanation, numerous specific details are set forth in order to provide a thorough understanding of the embodiments. It is apparent, however, to one skilled in the art that the embodiments may be practiced without these specific details or with an equivalent arrangement. In other instances, well-known structures and devices are shown in block diagram form in order to avoid unnecessarily obscuring the embodiments.

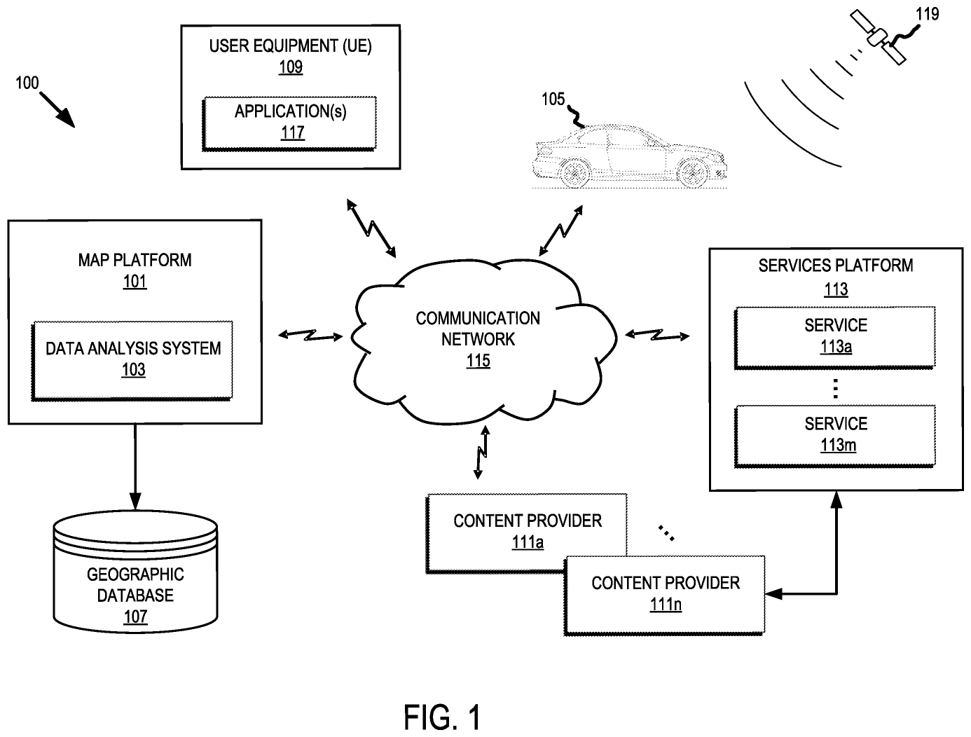

Referring to FIG. 1, the map platform 101 can be a standalone server or a component of another device with connectivity to the communication network 115. For example, the component can be part of an edge computing network where remote computing devices (not shown) are installed along or within proximity of a given geographical area.

The communication network 115 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, fifth generation mobile (5G) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the map platform 101 may be a platform with multiple interconnected components. The map platform 101 may include multiple servers, intelligent networking devices, computing devices, components and corresponding software for generating information for determining a public transportation score or other map functions. In addition, it is noted that the map platform 101 may be a separate entity of the system 100, a part of one or more services 113a-113m of a services platform 113.

The services platform 113 may include any type of one or more services 113a-113m. By way of example, the one or more services 113a-113m may include weather services, mapping services, navigation services, travel planning services, notification services, social networking services, content (e.g., audio, video, images, etc.) provisioning services, application services, storage services, information for determining a public transportation score, location-based services, news services, etc. In one embodiment, the services platform 113 may interact with the map platform 101, and/or one or more content providers 111a-111n to provide the one or more services 113a-113m.

In one embodiment, the one or more content providers 111a-111n may provide content or data to the map platform 101, and/or the one or more services 113a-113m. The content provided may be any type of content, mapping content, textual content, audio content, video content, image content, etc. In one embodiment, the one or more content providers 111a-111n may provide content that may aid in determining a public transportation score according to the various embodiments described herein. In one embodiment, the one or more content providers 111a-111n may also store content associated with the map platform 101, and/or the one or more services 113a-113m. In another embodiment, the one or more content providers 111a-111n may manage access to a central repository of data, and offer a consistent, standard interface to data.

By way of example, the user equipment (UE) 109 may be, or include, an embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 109 may support any type of interface with a user (e.g., by way of various buttons, touch screens, consoles, displays, speakers, “wearable” circuitry, and other I/O elements or devices). Although shown in FIG. 1 as being separate from the vehicle 105, in some embodiments, the UE 109 may be integrated into, or part of, the vehicle 105.

In one embodiment, the UE 109, may execute one or more applications 117 (e.g., software applications) configured to carry out steps in accordance with methods described here. For instance, in one non-limiting example, the application 117 may carry out steps for determining a public transportation score. In another non-limiting example, application 117 may also be any type of application that is executable on the UE 109 and/or vehicle 105, such as autonomous driving applications, mapping applications, location-based service applications, navigation applications, content provisioning services, camera/imaging application, media player applications, social networking applications, calendar applications, and the like. In yet another non-limiting example, the application 117 may act as a client for the data analysis system 103 and perform one or more functions associated with determining a public transportation score, either alone or in combination with the data analysis system 103.

In some embodiments, the UE 109 and/or the vehicle 105 may include various sensors for acquiring a variety of different data or information. For instance, the UE 109, and/or the vehicle 105 may include one or more camera/imaging devices for capturing imagery (e.g., terrestrial images), global positioning system (GPS) sensors or Global Navigation Satellite System (GNSS) sensors for gathering location or coordinates data, network detection sensors for detecting wireless signals, receivers for carrying out different short-range communications (e.g., Bluetooth, Wi-Fi, Li-Fi, near field communication (NFC) etc.), temporal information sensors, Light Detection and Ranging (LIDAR) sensors, Radio Detection and Ranging (RADAR) sensors, audio recorders for gathering audio data, velocity sensors, switch sensors for determining whether one or more vehicle switches are engaged, and others.

The UE 109 and/or the vehicle 105 may also include one or more light sensors, height sensors, accelerometers (e.g., for determining acceleration and vehicle orientation), magnetometers, gyroscopes, inertial measurement units (IMUs), tilt sensors (e.g., for detecting the degree of incline or decline), moisture sensors, pressure sensors, and so forth. Further, the UE 109 and/or the vehicle 105 may also include sensors for detecting the relative distance of the vehicle 105 from a lane or roadway, the presence of other vehicles, pedestrians, traffic lights, lane markings, speed limits, road dividers, potholes, and any other objects, or a combination thereof. Other sensors may also be configured to detect weather data, traffic information, or a combination thereof. Yet other sensors may also be configured to determine the status of various control elements of the car, such as activation of wipers, use of a brake pedal, use of an acceleration pedal, angle of the steering wheel, activation of hazard lights, activation of head lights, and so forth.

In some embodiments, the UE 109 and/or the vehicle 105 may include GPS, GNSS or other satellite-based receivers configured to obtain geographic coordinates from a satellite 119 for determining current location and time. Further, the location can be determined by visual odometry, triangulation systems such as A-GPS, Cell of Origin, or other location extrapolation technologies, and so forth. In some embodiments, two or more sensors or receivers may be co-located with other sensors on the UE 109 and/or the vehicle 105.

By way of example, the map platform 101, the services platform 113, and/or the one or more content providers 111a-111n communicate with each other and other components of the system 100 using well known, new or still developing protocols. In this context, a protocol includes a set of rules defining how the network nodes within the communication network 115 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

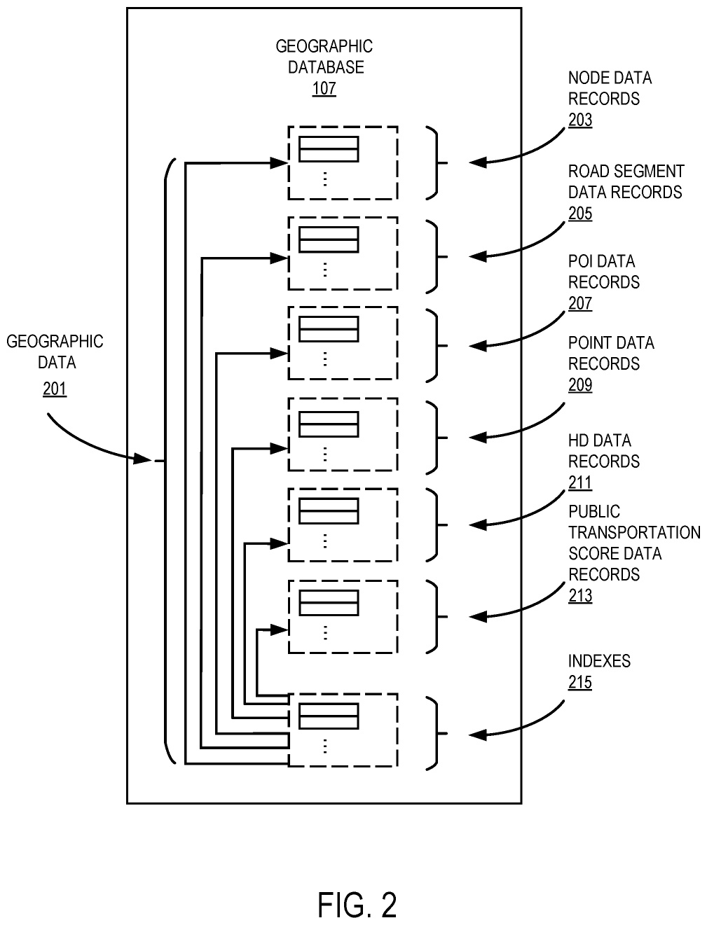

FIG. 2 is a diagram of the geographic database 107 of system 100, according to exemplary embodiments. In the exemplary embodiments, the information generated by the map platform 101 can be stored, associated with, and/or linked to the geographic database 107 or data thereof. In one embodiment, the geographic database 107 includes geographic data 201 used for (or configured to be compiled to be used for) mapping and/or navigation-related services, such as for personalized route determination, according to exemplary embodiments. For example, the geographic database 107 includes node data records 203, road segment data records 205, POI data records 207, point data records 209, HD data records 211, public transportation score data records 213, and indexes 215, for example. More, fewer or different data records can be provided. In one embodiment, other data records include cartographic (“carto”) data records, routing data, traffic data, weather data, and maneuver data. In one example, the other data records include data that is associated with certain POIs, roads, or geographic areas. In one example, the data is stored for utilization by a third-party. In one embodiment, the other data records include weather data records such as weather data reports. In one embodiment, the other data records include traffic data records such as traffic data reports. For example, the weather data records or the traffic data records can be associated with any of the map features stored in the geographic database 107 (e.g., a specific road or link, node, intersection, area, POI, etc.) on which the weather data or traffic data was collected. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using the point-based map matching embodiments describes herein), for example.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions, models, routes, etc. Accordingly, the terms polygons and polygon extrusions/models as used herein can be used interchangeably.

In one embodiment, the following terminology applies to the representation of geographic features in the geographic database 107.

“Node”— A point that terminates a link.

“Line segment”— A straight line connecting two points.

“Link” (or “edge”)—A contiguous, non-branching string of one or more line segments terminating in a node at each end.

“Shape point”— A point along a link between two nodes (e.g., used to alter a shape of the link without defining new nodes).

“Oriented link”— A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 107 follows certain conventions. For example, links do not cross themselves and do not cross each other except at a node or vertex. Also, there are no duplicated shape points, nodes, or links. Two links that connect each other have a common node or vertex. In the geographic database 107, overlapping geographic features are represented by overlapping polygons. When polygons overlap, the boundary of one polygon crosses the boundary of the other polygon. In the geographic database 107, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

In one embodiment, the geographic database 107 is presented according to a hierarchical or multi-level tile projection. More specifically, in one embodiment, the geographic database 107 may be defined according to a normalized Mercator projection. Other projections may be used. In one embodiment, a map tile grid of a Mercator or similar projection can a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grids. Because of the numbering system, the exact position of any tile in any level of the map tile grid or projection may be uniquely determined from the tile ID.

In one embodiment, the system 100 may identify a tile by a quadkey determined based on the tile ID of a tile of the map tile grid. The quadkey, for example, is a one dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid in order to maintain a constant length for the one-dimensional array of the quadkey. In another example, the length of the one-dimensional array of the quadkey may indicate the corresponding level within the map tile grid. In one embodiment, the quadkey is an example of the hash or encoding scheme of the respective geographical coordinates of a geographical data point that can be used to identify a tile in which the geographical data point is located.

In exemplary embodiments, the road segment data records 205 are links or segments representing roads, streets, or paths, as can be used in the calculated route or recorded route information for determination of one or more personalized routes, according to exemplary embodiments. The node data records 203 are end points or vertices (such as intersections) corresponding to the respective links or segments of the road segment data records 205. The road segment data records 205 and the node data records 203 represent a road network, such as used by vehicles, cars, and/or other entities. Alternatively, the geographic database 107 can contain path segment and node data records or other data that represent pedestrian paths or areas in addition to or instead of the vehicle road record data, for example. In one embodiment, the road or path segments can include an altitude component to extend to paths or road into three-dimensional space (e.g., to cover changes in altitude and contours of different map features, and/or to cover paths traversing a three-dimensional airspace).

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 107 can include data about the POIs and their respective locations in the POI data records 207. In one example, the POI data records 207 may include the hours of operation for various businesses. The geographic database 107 can also include data about places, such as cities, towns, or other communities, and other geographic features, such as bodies of water, mountain ranges, etc. Such place or feature data can be part of the POI data records 207 or can be associated with POIs or POI data records 207 (such as a data point used for displaying or representing a position of a city).

As shown in FIG. 2, the geographic database 107 may also include point data records 209 for storing the point data, map features, as well as other related data used according to the various embodiments described herein. In addition, the point data records 209 can also store ground truth training and evaluation data, machine learning models, annotated observations, and/or any other data. By way of example, the point data records 209 can be associated with one or more of the node data records 203, road segment data records 205, and/or POI data records 207 to support verification, localization or visual odometry based on the features stored therein and the corresponding estimated quality of the features. In this way, the point data records 209 can also be associated with or used to classify the characteristics or metadata of the corresponding records 203, 205, and/or 207.

As discussed above, the HD data records 211 may include models of road surfaces and other map features to centimeter-level or better accuracy. The HD data records 211 may also include models that provide the precise lane geometry with lane boundaries, as well as rich attributes of the lane models. These rich attributes may include, but are not limited to, lane traversal information, lane types, lane marking types, lane level speed limit information, and/or the like. In one embodiment, the HD data records 211 may be divided into spatial partitions of varying sizes to provide HD mapping data to vehicles and other end user devices with near real-time speed without overloading the available resources of these vehicles and devices (e.g., computational, memory, bandwidth, etc. resources). In some implementations, the HD data records 211 may be created from high-resolution 3D mesh or point-cloud data generated, for instance, from LiDAR-equipped vehicles. The 3D mesh or point-cloud data may be processed to create 3D representations of a street or geographic environment at centimeter-level accuracy for storage in the HD data records 211.

In one embodiment, the HD data records 211 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the public transportation score data records 213 include resilience data associated with one or more elements of a public transportation network. In one example, the resilience data may include data determined by an analysis of the reliability of one or more elements of the public transportation network. In one example, the public transportation score data 213 are stored for utilization by a third-party. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using the point-based map matching embodiments describes herein), for example.

The indexes 215 in FIG. 2 may be used improve the speed of data retrieval operations in the geographic database 107. Specifically, the indexes 215 may be used to quickly locate data without having to search every row in the geographic database 107 every time it is accessed. For example, in one embodiment, the indexes 215 can be a spatial index of the polygon points associated with stored feature polygons.

The geographic database 107 can be maintained by the one or more content providers 111a-111n in association with the services platform 113 (e.g., a map developer). The map developer can collect geographic data to generate and enhance the geographic database 107. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 107 can be a master geographic database stored in a format that facilitates updating, maintenance, and development. For example, the master geographic database 107 or data in the master geographic database 107 can be in an Oracle spatial format or other spatial format (for example, accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

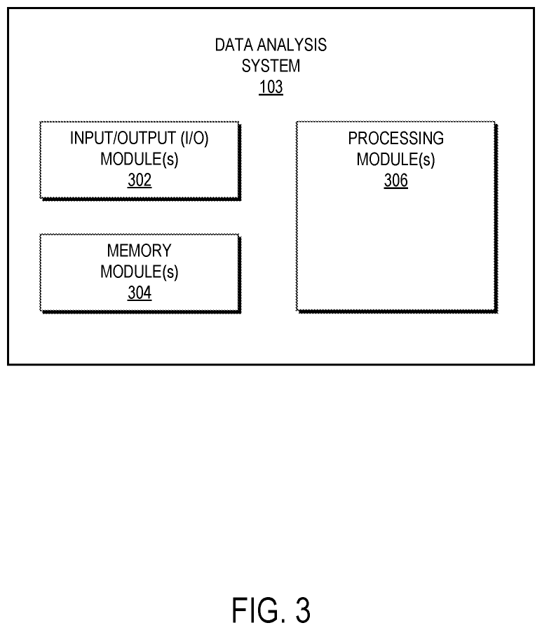

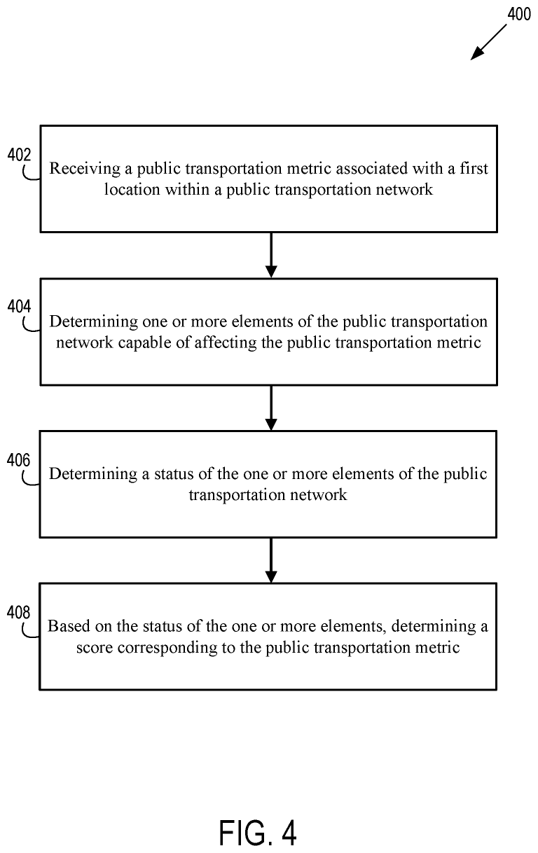

FIG. 3 is a diagram of the components of the data analysis system 103 of FIG. 1, according to one embodiment. By way of example, the data analysis system 103 includes one or more components for determining a public transportation score according to the various embodiments described herein. It is contemplated that the functions of these components may be combined or performed by other components of equivalent functionality. In this embodiment, data analysis system 103 includes in input/output module 302, a memory module 304, and a processing module 306. The above presented modules and components of the data analysis system 103 can be implemented in hardware, firmware, software, or a combination thereof. Though depicted as a separate entity in FIG. 1, it is contemplated that the data analysis system 103 may be implemented as a module of any of the components of the system 100 (e.g., a component of the services platform 113, etc.). In another embodiment, one or more of the modules 302-306 may be implemented as a cloud-based service, local service, native application, or combination thereof. The functions of these modules are discussed with respect to FIG. 4 below.

FIG. 4 is a flowchart of an example method, in accordance with at least some of the embodiments described herein. Although the blocks in FIG. 4 are illustrated in a sequential order, the blocks may in some instances be performed in parallel, and/or in a different order than those described therein. Also, the various blocks may be combined into fewer blocks, divided into additional blocks, and/or removed based upon the desired implementation.

In addition, the flowchart of FIG. 4 shows the functionality and operation of one possible implementation of the present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer-readable media that stores data for short periods of time, such as register memory, processor cache, or Random Access Memory (RAM), and/or persistent long term storage, such as read only memory (ROM), optical or magnetic disks, or compact-disc read only memory (CD-ROM), for example. The computer readable media may also be, or include, any other volatile or non-volatile storage systems. The computer readable medium may be considered a computer readable storage medium, a tangible storage device, or other article of manufacture, for example.

Alternatively, each block in FIG. 4 may represent circuitry that is wired to perform the specific logical functions in the process. Illustrative methods, such as the method shown in FIG. 4, may be carried out in whole or in part by a component or components in the cloud and/or system. However, it should be understood that the example method may instead be carried out by other entities or combinations of entities (i.e., by other computing devices and/or combinations of computing devices), without departing from the scope of the invention. For example, functions of the method of FIG. 4, may be fully performed by a computing device (or components of a computing device such as one or more processors), or may be distributed across multiple components of the computing device, across multiple computing devices, and/or across a server.

Referring to FIG. 4, an example method 400 may include one or more operations, functions, or actions as illustrated by blocks 402-408. The blocks 402-408 may be repeated periodically or performed intermittently, or as prompted by a user, device or system. In one embodiment, the method 400 is implemented in whole or in part by the data analysis system 103 of FIG. 3.

As shown by block 402, the method 400 includes receiving a public transportation metric associated with a first location within a public transportation network. In one example, the processing module 306 of FIG. 3 is configured to receive a public transportation metric associated with a first location within a public transportation network. In one example, the public transportation metric is a duration of time between an origin and a destination. In this example, the duration of time between the origin and the destination is a duration of time based on an individual reaching the destination via the first location of the public transportation network. In another example, the public transportation metric is a duration of time to board a transport vehicle at the first location of the public transportation network based on a second location.

In one example, the duration of time to board a transport vehicle at the first location of the public transportation network is based on a transit mode for a navigation route between the first location and the second location. The transit mode can be a type of transit to be employed by an individual in order to reach the first location associated with the public transportation network. The transit mode can include one or more transit modes to be employed by the individual in order to reach the departure location (e.g., the first location) associated with the public transportation network. For example, the transit mode can include a walking transit mode, a bicycling mode, a ride service transit mode, an on-demand vehicle service transit mode, a scooter transit mode, and/or another type of transit mode associated with the navigation route.

In another example, the duration of time to board a transport vehicle at the first location of the public transportation network is based on historical transit time data for a navigation route between the first location and the second location. In certain embodiments, the historical transit time data is indicative of a historical amount of time to travel between a starting location and the departure location associated with the public transport boarding location for the public transport. In one or more embodiments, the transit time data is based on a standard transit time (e.g., standard walking pace time, standard bicycle pace time, standard scooter pace time, etc.) for an individual and/or a group of individuals. The historical amount of time to travel between the starting location and the departure location can be determined based on an aggregation of travel times for historical trips. In certain embodiments, the historical transit time data is indicative of information related to probe points stored in one or more map layers associated with the navigation route between the first location and the second location.

In one example, the duration of time to board a transport vehicle at the first location of the public transportation network is based on user profile data. In certain embodiments, the user profile data can additionally or alternatively include user preferences, user characteristics (e.g., an average walking stride length for the individual, an average walking speed of the individual), fitness activity data from a computing device (e.g., an activity tracker device, a smartphone device, a smartwatch device, etc.), and/or other data associated with the individual.

In another example, the duration of time to board a transport vehicle at the first location of the public transportation network is based on environmental data for the starting location and/or the navigation route. In certain embodiments, the environmental data can include one or more environmental conditions (e.g., a weather condition, etc.) associated with the starting location and/or the navigation route. In certain embodiments, the environmental data can include one or more road conditions (e.g., real-time road condition data, historical road condition data, a vehicle traffic condition, a road construction condition, a pedestrian traffic condition, etc.) associated with the starting location and/or the navigation route.

In one example, the duration of time to board a transport vehicle at the first location is based on waiting time data indicative of a predicted amount of time to wait at the first location prior to departure via the public transport. In one example, the waiting time data is based on public transport timetable data. The public transport timetable data can be, for example, a schedule for a public transport. For example, the public transport timetable data can include train schedule data associated with one or more scheduled departures of a train, bus schedule data associated with one or more scheduled departures of a bus, ride service vehicle data associated with one or more historical departures for a ride service vehicle, and/or other public transport schedule data associated with one or more scheduled departures of another public transport. In certain embodiments, the public transport timetable data can include historical data associated with a comparison between a scheduled departure time and an actual departure time of a public transport. In certain embodiments, the public transport timetable data can additionally or alternatively include historical data associated with historical waiting times for one or more historical trips for one or more individuals. The public transport timetable data can additionally or alternatively include location data historical departures. In certain embodiments, the public transport timetable data can additionally or alternatively include historical probe points for respective public transports.

In one example, the duration of time to board a transport vehicle at the first location of the public transportation network based on a second location is a combination of a transit time corresponding to a transit mode (e.g., an amount of time to walk to the first location, an amount of time to bike to the first location, etc.) and a waiting time at the first location. In another example, the duration of time to board a transport vehicle at the first location of the public transportation network based on a second location is a combination of a historical transit time data and a waiting time at the first location. In one example, the duration of time to board a transport vehicle at the first location of the public transportation network based on a second location is a combination of a user profile data and a waiting time at the first location. In another example, the duration of time to board a transport vehicle at the first location of the public transportation network based on a second location is a combination of environmental data and a waiting time at the first location.

As shown by block 404, the method 400 also includes determining one or more elements of the public transportation network capable of affecting the public transportation metric. In one example, the processing module 306 of FIG. 3 is configured to determine one or more elements of the public transportation network capable of affecting the public transportation metric. In one example, the public transportation network is a rail transportation network. In one example, the one or more elements includes one or more infrastructure components. For example, the one or more infrastructure components may be one or more stations for accessing a train, one or more platforms for boarding a train, and/or one or more tracks used by one or more trains. In another example, the one or more elements include one or more transport vehicles that are a part of the public transportation network.

As shown by block 406, the method 400 also includes determining a status of the one or more elements of the public transportation network. In one example, the processing module 306 of FIG. 3 is configured to determine a status of the one or more elements of the public transportation network. In one example, the status of the one or more elements is a binary status (e.g., open, closed, available, unavailable, etc.). For example, the one or more elements may be either available or unavailable for use by individuals. In one example, determining the status of the one or more elements of the public transportation network includes simulating a closure of the one or more elements of the public transportation network. In one example, the system 100 may be configured to simulate the closure of a single stop within a public transportation network. In another example, the system 100 may be configured to simulate the closure of a line within the public transportation network. In one example, the system 100 may be configured to simulate the closure of a track win the public transportation network.

As shown by block 408, the method 400 also includes, based on the status of the one or more elements, determining a score corresponding to the public transportation metric. In one example, the processing module 306 of FIG. 3 is configured to, based on the status of the one or more elements, determine a score corresponding to the public transportation metric. In one example, the system 100 may determine a percentage drop in the ability of an individual to utilize the public transportation network it to a destination that based on the closure of a stop within the public transportation. In one example, if a stop is closed and that is the only stop within a predetermined distance from a given location (e.g., workplace) of an individual, then the system 100 may be configured to determine a 100 percent drop in the ability for the individual to make it to a destination (e.g., home) via that stop. For example, the system 100 may be configured to determine a 90% probability that the duration of time between a given origin and a given destination is 45 minutes for a particular individual associated with the given origin and the given destination. In this example, based on the closure of the only stop within a predetermined distance, the system 100 may be configured to calculate a 0% probability that the duration of time between the given origin and the given destination is 45 minutes for that particular individual associated with the given origin and the given destination.

In another example, if a stop is closed but there is an additional stop that is within a predetermined distance from a given location (e.g., home) of an individual, then the system 100 may be configured to determine a 50 percent drop in the ability for the individual to make it to a destination (e.g., school). For example, the system 100 may be configured to determine a 90% probability that the duration of time between a given origin and a given destination is 45 minutes for an individual associated with the given origin and the given destination. In this example, based on the closure of one of two stops within a predetermined distance, the system 100 may be configured to calculate a 45% probability that the duration of time between the given origin and the given destination is 45 minutes for that individual associated with the given origin and the given destination.

In another example, if a train line is unavailable but there is two additional train lines that are operating within a predetermined window of time, then the system 100 may be configured to determine a 33 percent drop in the ability for an individual to make it to a destination using one of the remaining available train lines. For example, the system 100 may be configured to determine a 75% probability that there will be a train line available during a predetermined window of time for an individual to board at a particular origin and arrive at a particular destination. In this example, based on the closure of one of three train during the predetermined window of time, the system 100 may be configured to determine a 50% probability that that there will be a train line available during a predetermined window of time for an individual to board at a particular origin and arrive at a particular destination.

In another example, if a track used by multiple trains is shut down and there no alternative tracks, then the system 100 may be configured to determine a 100 percent drop in the ability for an individual to make it to a destination using any train that requires the use of the track. For example, the system 100 may be configured to determine a 80% probability that track is available for use by multiple trains during a predetermined window of time for an individual to board at a particular origin and arrive at a particular destination. In this example, based on the closure of one track used by multiple trains during the predetermined window of time, the system 100 may be configured to determine a 0% probability that that is able to reach a destination within a given duration of time.

In one embodiment, the method 400 may further include, based on the score, determining one or more routes for utilizing the public transportation network that do not include accessing the public transportation network via the first location. In one example, the processing module 306 of FIG. 3 is configured to, based on the score, determine one or more routes for utilizing the public transportation network that do not include accessing the public transportation network via the first location. In one example, the system 100 may be configured to determine an alternative stop for an individual to utilize the public transportation network that is within a predetermined distance of a given location of the individual. The system 100 may be configured to take into consideration various other factors (e.g., weather, traffic, events, etc.) that could contribute to affect the time it takes to reach the alternative stop for the individual to utilize the public transportation network.

In another embodiment, the method 400 may further include, based on the score, determining one or more routes for utilizing a second public transportation network. In one example, the processing module 306 of FIG. 3 is configured to, based on the score, determine one or more routes for utilizing a second public transportation network. In one example, the system 100 may be configured to determine one or more stops for an individual to utilize a second public transportation network that is within a predetermined distance of a given location of the individual. The system 100 may be configured to take into consideration various other factors (e.g., weather, traffic, events, etc.) that could contribute to affect the time it takes to reach the one or more stops for the individual to utilize the second public transportation network.

The processes described herein for determining a public transportation score may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

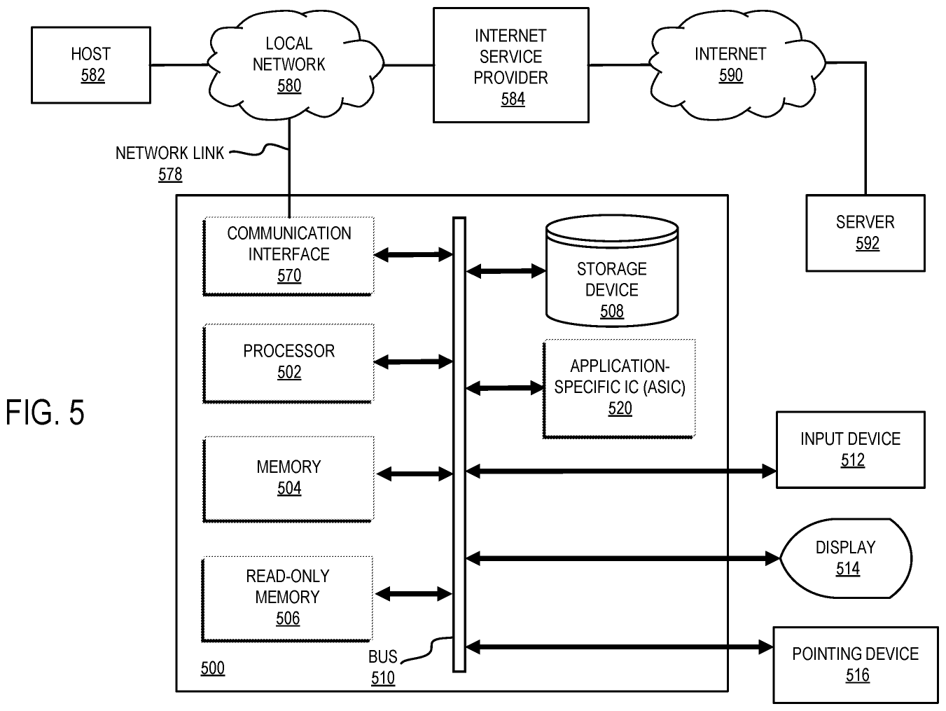

FIG. 5 illustrates a computer system 500 upon which an embodiment may be implemented. Computer system 500 is programmed (e.g., via computer program code or instructions) to provide information for determining a public transportation score as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 510 includes one or more parallel conductors of information so that information is transferred quickly among devices coupled to the bus 510. One or more processors 502 for processing information are coupled with the bus 510.

A processor 502 performs a set of operations on information as specified by computer program code related to determining a public transportation score. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or other dynamic storage device, stores information including processor instructions for determining a public transportation score. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 700 also includes a read only memory (ROM) 506 or other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for determining a public transportation score, is provided to the bus 510 for use by the processor from an external input device 512, such as a keyboard containing alphanumeric keys operated by a human user, or a sensor. A sensor detects conditions in its vicinity and transforms those detections into physical expression compatible with the measurable phenomenon used to represent information in computer system 500. Other external devices coupled to bus 510, used primarily for interacting with humans, include a display 514, such as a cathode ray tube (CRT) or a liquid crystal display (LCD), or plasma screen or printer for presenting text or images, and a pointing device 516, such as a mouse or a trackball or cursor direction keys, or motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of application specific ICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

The computer system 500 may also include one or more instances of a communications interface 570 coupled to bus 510. The communication interface 570 may provide a one-way or two-way communication coupling to a variety of external devices that operate with their own processors, such as printers, scanners and external disks. In addition, the communication interface 570 may provide a coupling to a local network 580, by way of a network link 578. The local network 580 may provide access to a variety of external devices and systems, each having their own processors and other hardware. For example, the local network 580 may provide access to a host 582, or an internet service provider 584, or both, as shown in FIG. 5. The internet service provider 584 may then provide access to the Internet 590, in communication with various other servers 592.

Computer system 500 also includes one or more instances of a communication interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, the communication interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, the communication interface 570 may be a local area network (LAN) card to provide a data communication connection to a compatible LAN, such as Ethernet. Wireless links may also be implemented. For wireless links, the communication interface 570 sends or receives or both sends and receives electrical, acoustic or electromagnetic signals, including infrared and optical signals, that carry information streams, such as digital data. For example, in wireless handheld devices, such as mobile telephones like cell phones, the communication interface 570 includes a radio band electromagnetic transmitter and receiver called a radio transceiver. In certain embodiments, the communication interface 570 enables connection to the communication network 115 of FIG. 1 for providing information for determining a public transportation score.

The term computer-readable medium is used herein to refer to any medium that participates in providing information to processor 502, including instructions for execution. Such a medium may take many forms, including, but not limited to, non-volatile media, volatile media and transmission media. Non-volatile media include, for example, optical or magnetic disks, such as storage device 508. Volatile media include, for example, dynamic memory 504. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

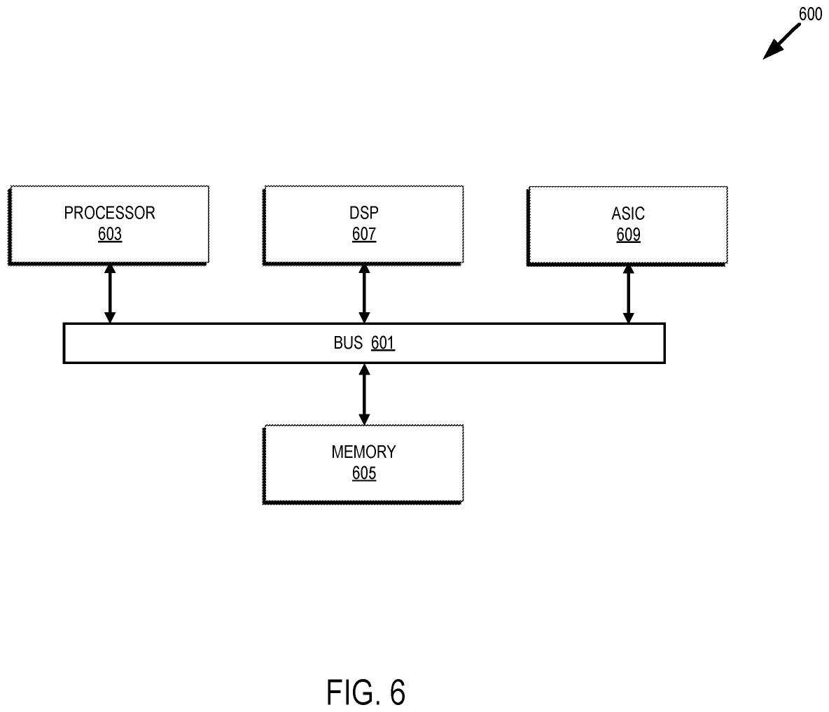

FIG. 6 illustrates a chip set 600 upon which an embodiment may be implemented. Chip set 600 is programmed to determine a public transportation score as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the steps described herein to provide information for determining a public transportation score. The memory 605 also stores the data associated with or generated by the execution of the inventive steps.

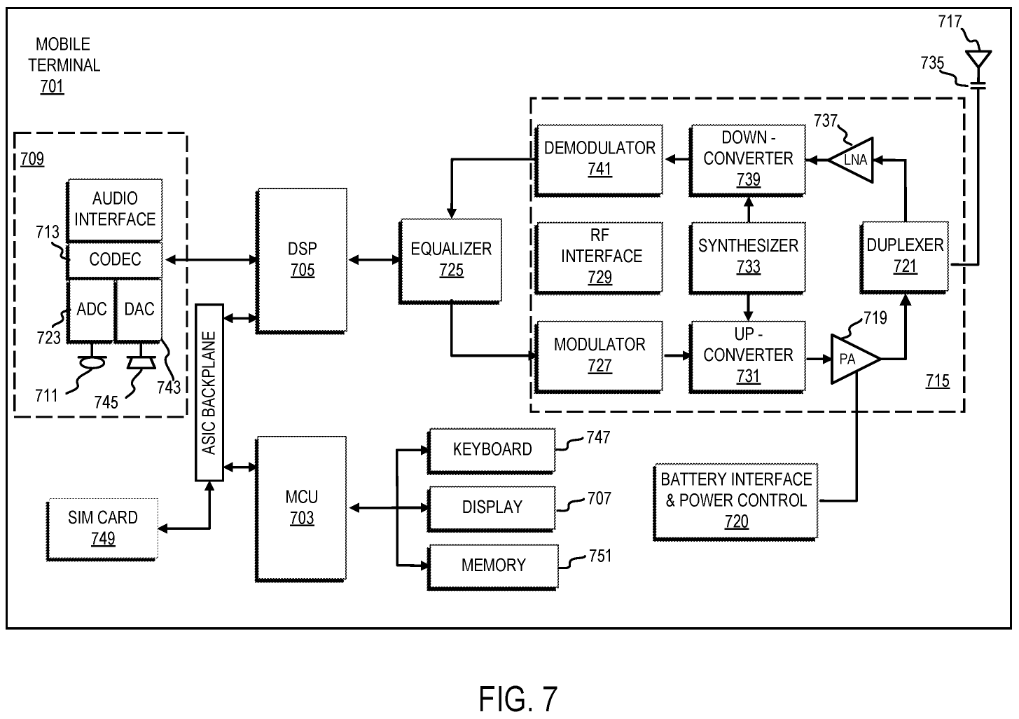

FIG. 7 is a diagram of exemplary components of a mobile terminal 701 (e.g., a mobile device, vehicle, and/or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile station functions that offer automatic contact matching. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G networks, code division multiple access (CDMA), wireless fidelity (WiFi), satellite, and the like.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703—which can be implemented as a Central Processing Unit (CPU) (not shown).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile station 701 to provide information for determining a public transportation score. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the station. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 751 may be, but not limited to, a single memory, CD, DVD, ROM, RAM, EEPROM, optical storage, or any other non-volatile or non-transitory storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile station settings.

While features have been described in connection with a number of embodiments and implementations, various obvious modifications and equivalent arrangements, which fall within the purview of the appended claims are envisioned. Although features are expressed in certain combinations among the claims, it is contemplated that these features can be arranged in any combination and order.

1. A computer-implemented method of determining a public transportation score, the method comprising:
receiving, by a processor, a public transportation metric associated with a first location within a public transportation network;
determining, by the processor, one or more elements of the public transportation network capable of affecting the public transportation metric;
determining, by the processor, a status of the one or more elements of the public transportation network; and
based on the status of the one or more elements, determining, by the processor, a score corresponding to the public transportation metric, where the score comprises a probability of an availability of the one or more elements, a probability of an individual reaching a second destination with the public transportation network, a probability of a time delay for the individual to travel from the first destination to the second destination, or a combination thereof.

2. The method of claim 1, wherein the public transportation network is a rail transportation network.

3. The method of claim 1, wherein the one or more elements includes one or more infrastructure components.

4. The method of claim 1, the method further comprising:
based on the score, determining one or more routes for utilizing the public transportation network that do not include accessing the public transportation network via the first location.

5. The method of claim 1, the method further comprising:
based on the score, determining one or more routes for utilizing a second public transportation network.

6. The method of claim 1, wherein the public transportation metric is a duration of time to board a transport vehicle at the first location of the public transportation network based on a second location.

7. The method of claim 1, wherein the public transportation metric is a duration of time between an origin and a destination.

8. An apparatus for determining a public transportation score, the apparatus comprising:
a processor; and
a memory comprising computer program code for one or more programs, wherein the memory and the computer program code is configured to cause the processor of the apparatus to:
receive a public transportation metric associated with a first location of a public transportation network;
determine one or more elements of the public transportation network capable of affecting the public transportation metric;
determine a status of the one or more elements of the public transportation network; and
based on the status of the one or more elements, determine a score corresponding to the public transportation metric, where the score comprises a probability of an availability of the one or more elements, a probability of an individual reaching a second destination with the public transportation network, a probability of a time delay for the individual to travel from the first destination to the second destination, or a combination thereof.

9. The apparatus of claim 8, wherein the public transportation network is a rail transportation network, wherein the one or more elements includes one or more infrastructure components.

10. The apparatus of claim 8, wherein the computer program code is configured to further causes the processor of the apparatus to:
based on the score, determine one or more routes for utilizing the public transportation network that do not include accessing the public transportation network via the first location.

11. The apparatus of claim 8, wherein the computer program code is configured to further causes the processor of the apparatus to:
based on the score, determine one or more routes for utilizing a second public transportation network.

12. The apparatus of claim 8, wherein the computer program code is configured to cause the processor of the apparatus to determine the status of the one or more elements of the public transportation network further causes the processor of the apparatus to simulate a closure of a single stop within the public transportation network, a line within the public transportation network and/or a track within the public transportation network out of the one or more elements of the public transportation network.

13. The apparatus of claim 8, wherein the public transportation metric is a duration of time to board a transport vehicle at the first location of the public transportation network based on a second location.

14. The apparatus of claim 8, wherein the public transportation metric is a duration of time between an origin and a destination.

15. A non-transitory computer-readable storage medium comprising one or more instructions for execution by one or more processors of a device, the one or more instructions which, when executed by the one or more processors, cause the device to:
receive a public transportation metric associated with a first location of a public transportation network;
determine one or more elements of the public transportation network capable of affecting the public transportation metric;
determine a status of the one or more elements of the public transportation network; and
based on the status of the one or more elements, determine a score corresponding to the public transportation metric, where the score comprises a probability of an availability of the one or more elements, a probability of an individual reaching a second destination with the public transportation network, a probability of a time delay for the individual to travel from the first destination to the second destination, or a combination thereof.

16. The non-transitory computer-readable storage medium of claim 15, wherein the public transportation network is a rail transportation network, wherein the one or more elements includes one or more infrastructure components.

17. The non-transitory computer-readable storage medium of claim 15, wherein the one or more instructions which, when executed by the one or more processors, further cause the device to:
based on the score, determine one or more routes for utilizing the public transportation network that do not include accessing the public transportation network via the first location.

18. The non-transitory computer-readable storage medium of claim 15, wherein the one or more instructions which, when executed by the one or more processors, further cause the device to:
based on the score, determine one or more routes for utilizing a second public transportation network.

19. The non-transitory computer-readable storage medium of claim 15, wherein the one or more instructions which, when executed by the one or more processors, cause the device to determine the status of the one or more elements of the public transportation network further cause the device to simulate a closure of a single stop within the public transportation network, a line within the public transportation network and/or a track within the public transportation network out of the one or more elements of the public transportation network.

20. The non-transitory computer-readable storage medium of claim 15, wherein the public transportation metric is a duration of time to board a transport vehicle at the first location of the public transportation network based on a second location.
